(19) United States
(12) Patent Application Publication
(10) Pub. No.: US 2022/0180128 A1
(43) Pub. Date: Jun. 9, 2022

(54) METHOD AND SYSTEM OF PERFORMING GAP ANALYSIS

(71) Applicant: CurioSearch DBA Materiall, Milpitas, CA (US)

(72) Inventors: ROHIT JAIN, DANVILLE, CA (US); BHARAT VIJAY, FREMONT, CA (US); ANAND RAMANI, PLEASANTON, CA (US)

(73) Assignee: CurioSearch DBA Materiall, Milpitas, CA (US)

(21) Appl. No.: 17/110,299

(22) Filed: Dec. 3, 2020

(51) Int. Cl. G06K 9/62; G06Q 30/06; G06Q 10/06

(52) U.S. Cl. CPC G06K 9/6265; G06Q 10/06393; G06Q 30/0631

(57) ABSTRACT

Described herein is a method for evaluating the performance gap of a proposed personalization solution versus a default solution without the need for integration. The method comprises utilizing the historical data, the data including a sample of engagement and transactions of a specific audience, and catalog feed; simulating the user actions in two environments, the environments being the proposed solution and the default solution; comparing the product exposure data between the two environments, and generating a report analyzing the number of sessions with transactions and/or engagement in each environment.

### BACKGROUND

This invention in general relates to online business, and specifically relates to a method of providing a personalization solution to online users.

In the current technological climate there is a drive to provide personalized solutions to online users. The abundance of data has allowed systems to design personalized environments that are unique to a user's session. In many cases prior to implementing a personalization engine, the performance and success criteria between competing solutions must be analyzed. This is usually carried out in a simulated environment after integrating a proposed solution into the system workflow. Post-processing of the simulated data compares gross metrics to determine the efficiency and efficacy of a proposed personalization solution. There is a need for a technological solution that allows for efficiency and efficacy measurements without whole system integration as well as data metrics to compare proposed personalization solutions. A proposed methodology should allow providers to articulate the differences between various personalization environments as well as point the direction towards improvements and more robust personalization algorithms.

### BRIEF DESCRIPTION OF DRAWINGS

The invention, with its features and advantages will be more readily apparent from the following detailed description of the invention and the appended claims, when taken in conjunction with the accompanying drawings, in which:

FIG. 1 illustrates the steps of evaluating the performance gap of a proposed personalization solution versus a default solution;

FIG. 2 illustrates gap analysis workflow; and

FIG. 3 illustrates feedback loop system workflow.

### SUMMARY

A GAP analysis is a fundamental way to measure the effectiveness and efficiency of personalized recommendation engines. As an efficacy measure it computes the deviation between a proposed personalization system's understanding of user behavior and user signals as captured via user interaction with the system. Regarding efficiency, it allows for a dynamic interpretation which measures in real-time a system's ability to learn user preferences. The proposed methodology takes as input a generic attribute space and a meaningful collection of user actions and outputs a quantitative measure of efficacy and efficiency of the personalized recommendation system.

GAP analysis is used for post processing or historical analysis of user behavior and real-time adaptive learning. In both situations one may consider a GAP analysis that is personalized to an individual user's experience or an aggregate whole representing a meaningful population for analysis. Furthermore, the methodological framework of the GAP analysis provides a solution to the integration problem highlighted previously. In particular it allows for an evaluation of personalized solutions without requiring system integration, creating an offline simulated environment per user to measure the efficiency and efficacy of different personalized solutions, and publishing data metrics to evaluate solutions at an attribute level precision.

The system and method described herein illustrates the methodology underlying the GAP analysis as well as its application to learning systems. These two foundations help to define the generality of the GAP analysis and highlights its novel uses as a domain agnostic tool in the context of personalized recommendation systems. It provides a solution to avoid system integration when checking the performance of personalized solutions, evaluating personalized solutions at an attribute level, and can be expanded to help build an adaptive learning system to improve personalized solutions.

### DESCRIPTION

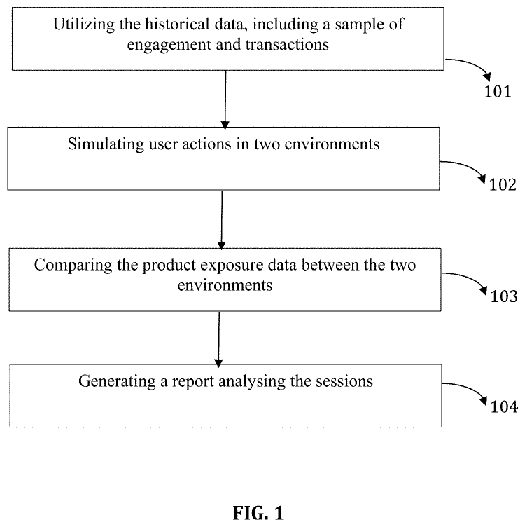

FIG. 1 illustrates the steps of evaluating the performance gap of a proposed personalization solution versus a default solution. The method comprises utilizing the historical data 101, the data including a sample of engagement and transactions of a specific audience, and catalog 203 feed; simulating the user actions in two environments 102, the environments being the proposed solution and the default solution; comparing the product exposure data between the two environments 103, and generating a report analyzing the number of sessions with transactions and/or engagement in each environment 104.

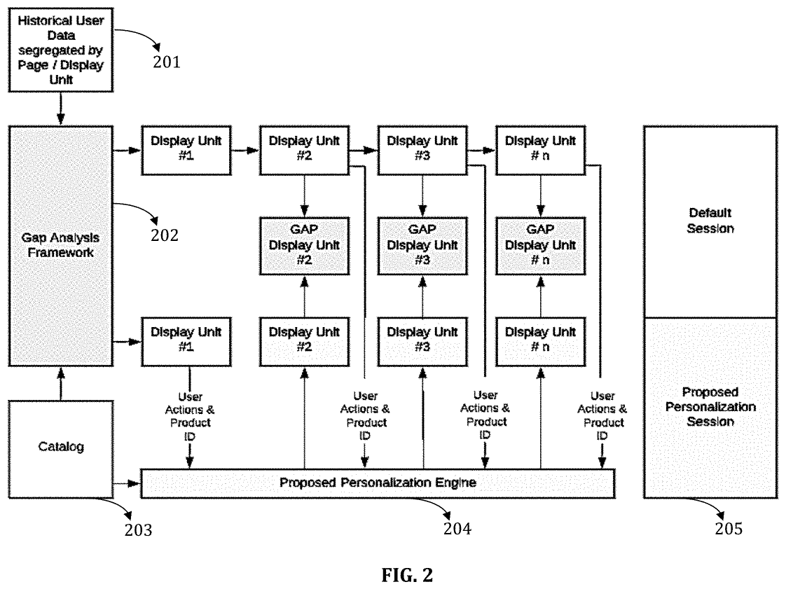

The proposed workflow of the GAP analysis can be implemented in both offline and online settings. The process is outlined in the following Gap Computation Methodology Workflow. FIG. 2 illustrates a gap analysis workflow. User Data is either collected in Real-Time or replayed historically. The simulation module is highlighted as Gap Analysis Framework 202. An additional input into the Gap Analysis Framework 202 is the catalog 203 used to generate the historical data 201. Within the GAP analysis framework 202 an additional recommendation engine, i.e. the proposed personalization engine, 203 is installed which will take as input the historical user actions as well as the catalog 103 items to generate its simulated display page (User Actions and Product ID).

At each step the real-time generated display page or historical replay is compared against the simulated personalized page. A display unit is defined to be the minimal number of displayed items in each iterative step needed to collect user actions prior to applying a recommendation update. At each step a GAP analysis is performed to compare the efficacy and efficiency of the default session against the proposed personalization session 205.

From a historical perspective, the GAP analysis can either be computed in a discrete time ordered way or across the entire user session. In the first approach the GAP computation measures in time how quickly a system converges to the user preference. In the latter, an overall efficacy measure can be computed to give an aggregate measure of a system's alignment to user preferences. Both the discrete time and aggregate can be measured per user or across all users of interest. The workflow allows for simulated environments without the need for system integration. The simulation can be carried out on a per user basis.

Described herein is an underlying methodology of the GAP analysis which aims to extract comparative metrics at the attribute level. For purposes of exposition we consider a simulated scenario limiting user actions to content clicking and content as defined by a universe of attributes. A GAP analysis is fundamentally based on a notion of user preference. The basic idea is that we model the GAP analysis as a user v. system problem. For each page we collect user click data and then check how well the system is matching those preferences.

We define the user variability per page, U=number of distinct combinations clicked on total number of distinct combinations. We also define the displayed page variability, P=number of distinct combinations displayed total number of distinct combinations. In order to measure the effectiveness of a given recommender system we compute the ratio, I=U/P.

Note that, 0≤I≤1, as a recommender system learns a user's preference (page by page) we find that the ratio should approximately converge to 1, I→1.

Hence to measure the GAP between two given recommendation systems we compute the above ratio and compare page by page which ratio is closer to 1. The above ratio is a metric to measure if a given recommendation system is aligning with user preferences. Moreover by comparing how fast two given algorithms converge to 1 we may compare the performance of the underlying recommendation systems.

Using the personalization factor introduced in the previous section we can compute the information entropy per page to measure how well the system has learned the user's preferences.

We define, the information entropy, S=−Σₖ (pk log pk) where pₖ is the probability distribution over the discrete outcomes k. In our case we can compute the information entropy for the personalization factor, S=−I log I−(1−I) log(1−I)

In the case when I>½, we say that the system is learning the user's preferences with certainty S. When I<½, we say that the system is not learning the user's preferences with certainty S.

When, I=½, then S=1, indicating maximum entropy and uncertainty for the recommendation system. A lower value for S indicates a higher degree of certainty in our assessment of the ability of our recommendation system to learn or not learn user preferences. As a general methodology the personalization factor helps to compare/contrast different recommendation engines. As explained in the next section, the personalized system entropy can be integrated into the workflow of a recommendation system pipeline to allow for adaptive learning. From a real-time perspective, the discrete time approach to measuring the GAP can be integrated with recommendation engines to allow for adaptive learning and improvements to the underlying recommendation engine.

Utilizing the methodology explained in the previous section we consider a system workflow to utilize the GAP analysis as a meta metric to frame the recommendation problem in the context of feedback loops. The basic idea is to keep track of the recommendation systems overall performance dynamically and give quantitative thresholds to amplify the system's response. If a system's performance can be tracked in real-time, quantitative thresholds can help modulate the output of a system's recommendation engine. As a basic example we consider a recommendation system that can be modeled as a gradation of learning algorithms. Based on the GAP analysis of a fixed output from the recommendation engine, a strong performance metric may amplify a system's preference for a given recommendation engine, while a weak performance allows the system to change in real-time to another recommendation engine and track the subsequent output.

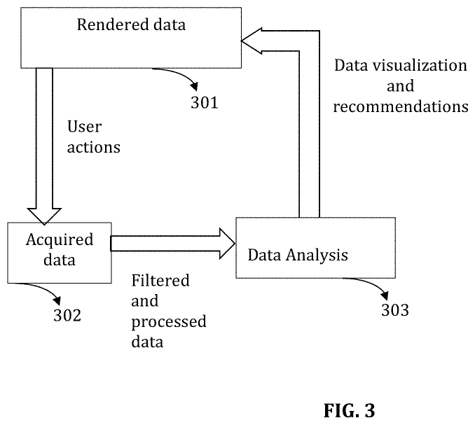

A basic schema for the feedback loop is illustrated in FIG. 3. In the diagram above rendered data 301 is equivalent to a fixed display unit as considered in the previous diagram. User actions are implicit or explicit feedback provided by the user when presented with the given display unit. Acquired data 302 is the collection of attributes associated with displayed items as well as user feedback. Filtering and processing are basic signal processing tests to eliminate noisy data. Data Analysis 303 is the basic implementation of 2+ recommendation engines based on the acquired data. Within data analysis GAP analysis is also computed to compare and contrast the efficiency and efficacy of the recommendation engines. Data visualization and recommendation refers to the rendering of the next display unit based on the outcomes of the analysis and choice of recommendation engine.

It is apparent in different embodiments that the various methods, algorithms, and computer programs disclosed herein are implemented on non-transitory computer readable storage media appropriately programmed for computing devices. The non-transitory computer readable storage media participate in providing data, for example, instructions that are read by a computer, a processor or a similar device. In different embodiments, the “non-transitory computer readable storage media” also refer to a single medium or multiple media, for example, a centralized database, a distributed database, and/or associated caches and servers that store one or more sets of instructions that are read by a computer, a processor or a similar device. The “non-transitory computer readable storage media” also refer to any medium capable of storing or encoding a set of instructions for execution by a computer, a processor or a similar device and that causes a computer, a processor or a similar device to perform any one or more of the methods disclosed herein. Common forms of the non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in various manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Fortran, Ruby, Perl®, Python®, Visual Basic®, hypertext preprocessor (PHP), Microsoft® .NET, Objective-C®, etc. Other object-oriented, functional, scripting, and/or logical programming languages can also be used. In an embodiment, the computer program codes or software programs are stored on or in one or more mediums as object code. In another embodiment, various aspects of the methods and the systems disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. In another embodiment, various aspects of the methods and the systems disclosed herein are implemented as programmed elements, or non-programmed elements, or any suitable combination thereof.

The methods and the systems disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The methods and the systems disclosed herein are not limited to a particular computer system platform, processor, operating system, or network. In an embodiment, one or more aspects of the methods and the systems disclosed herein are distributed among one or more computer systems, for example, servers configured to provide one or more services to one or more client computers, or to perform a complete task in a distributed system. For example, one or more aspects of the methods and the systems disclosed herein are performed on a client-server system that comprises components distributed among one or more server systems that perform multiple functions according to various embodiments. These components comprise, for example, executable, intermediate, or interpreted code, which communicate over a network using a communication protocol. The methods and the systems disclosed herein are not limited to be executable on any particular system or group of systems, and are not limited to any particular distributed architecture, network, or communication protocol.

What is claimed is:

1. A computer implemented method for evaluating a performance gap of a proposed personalization solution versus a default solution without need for system integration of a client device, comprising the steps of:
utilizing, by a computer device, historical data, said historical data including a sample of engagement and transactions of a specific user, and catalog feed;
simulating, by the computer device, user actions in two environments, said environments being said proposed solution and said default solution;
comparing, by the computer device, product exposure data between the two environments; and
generating, by the computer device, a report analyzing a number of sessions with transactions and/or engagement in each environment.

2. The method of claim 1, wherein said evaluation is an extraction of performance metrics at an attribute level.

3. The method of claim 2, wherein said performance metrics measures whether a given recommendation system is aligning with user preferences.

4. The method of claim 1, wherein said evaluation of the performance gap is computed across an entire user session.

5. The method of claim 1, wherein said evaluation of the performance gap is computed in a discrete time ordered way, and the said evaluation measures in time how quickly said system converges to said user's preference.

6. A computer implemented method of measuring a recommendation system's performance in learning a user's preference, comprising the steps of:
measuring a personalization factor, wherein said personalization factor is a measure of an alignment of the recommendation system with users preferences;
computing information entropy defined as ‘S” for the personalization factor, to measure how well the recommendation system has learned a user's preferences, wherein a lower value for entropy indicates a higher degree of certainty in an assessment of the ability of the recommendation system to learn or not learn user preferences; wherein S is computed as,
S=−Σₖ(pₖ log pₖ)
where pₖ is a probability distribution over discrete outcomes k,
S=−I log I−(1−I)log(1−I),
wherein, when I>½, the system is learning the user's preferences with certainty S,
when I<½, the system is not learning the user's preferences with certainty S,
when, I=½, then S=1, indicating maximum entropy and uncertainty for the recommendation system.

7. The method of claim 6, wherein said information entropy is applied as a meta metric to frame the recommendation system in context of feedback loops, and the recommendation system is modeled as a gradation of learning algorithms.

8. The method of claim 6, wherein said personalization factor is used as a metric to compare performance of different recommendation engines.

9. The method of claim 6, wherein said performance of the recommendation system is tracked in real-time, and quantitative thresholds modulate output of said system's recommendation engine.

10. The method of claim 6, wherein based on the measure of the personalization factor and its associated information entropy for a fixed output from a recommendation engine, a strong performance metric amplifies a recommendation system's preference for a given recommendation engine, while a weak performance allows the recommendation system to change in real-time to another recommendation engine and track the subsequent output of said another recommendation engine.

11. A computer implemented method of selecting between a plurality of personalization solutions offered to a specific user of a client device, comprising:
providing, by a computer device, a plurality of recommendation engines, wherein each recommendation engine provides a personalized solution;
measuring, by the computer device, a performance gap of each of said personalization solution versus a default solution without need for system integration, comprising the steps of:
utilizing historical data, said historical data including a sample of engagement and transactions of a specific user, and catalog feed;
simulating user actions in two environments, said environments being said personalized solution and said default solution;
comparing product exposure data between the two environments; and
computing a personalization factor for said personalized solution and default solution; and
selecting, by the computer device, one of said recommendation engines with the highest of said personalization factors.

12. A method of adaptive learning of a recommendation engine for a client device, comprising:
measuring, by a computer device, a performance gap of each of a personalization solution versus a default solution using a discrete time approach, without need for system integration, comprising the steps of:
utilizing historical data, said historical data including a sample of engagement and transactions of a specific user, and catalog feed;
simulating user actions in two environments, said environments being said proposed solution and said default solution;
comparing product exposure data between the two environments; and
computing a personalization factor for said proposed solution and default solution; and
tracking, by the computer device, performance of the recommendation engine in real-time, and setting quantitative thresholds to modulate the output of said recommendation engine.

13. A computer implemented system, comprising:
a processing subsystem;
and a memory subsystem storing instructions that cause the processing subsystem to perform operations comprising:
selecting a plurality of personalization solutions offered to a specific user of a client device, comprising the steps of:
providing a plurality of recommendation engines, wherein each recommendation engine provides a personalized solution;
measuring a performance gap of each of said personalization solution versus a default solution without need for system integration, comprising the steps of:
utilizing historical data, said historical data including a sample of engagement and transactions of a specific user, and catalog feed;
simulating user actions in two environments, said environments being said proposed solution and said default solution;
comparing product exposure data between the two environments; and
computing a personalization factor for said proposed solution and default solution; and
selecting one of said recommendation engines with the highest of said personalization factors.
